(19) United States
(12) Patent Application Publication
(10) Pub. No.: US 2005/0240462 A1
(43) Pub. Date: Oct. 27, 2005

(54) Method and apparatus for population segmentation

(76) Inventors: Kenneth L. Inman, Poway, CA (US); David R. Miller, Annandale, VA (US)

Correspondence Address: DUCKOR SPRADLING METZGER, 401 WEST A STREET, SUITE 2400, SAN DIEGO, CA, 92101-7915, US

(21) Appl. No.: 10/829,405

(22) Filed: Apr. 21, 2004

(51) Int. Cl. G06F 17/60

(52) U.S. Cl. 705/10

(57) ABSTRACT

A method and system are disclosed for segmenting a population, and include the defining of a base level population segmentation tree. A set of alternative level variables usable as substitutes in the nodes of the population segmentation tree are defined. Substitute split values for each node of the tree are determined to enable up and down shifting between levels.

### FIELD OF THE INVENTION

The present invention relates in general to method and apparatus for population segmentation. The invention relates more specifically to method and apparatus which may be used for multiple segmentation levels such as household levels, geographic levels and others.

### BACKGROUND ART

For marketing purposes, knowledge of customer behavior is important, if not crucial. For direct marketing, for example, it is desirable to focus the marketing on a portion of the segment likely to purchase the marketed product or service.

In this regard, several methods have traditionally been used to divide the customer population into segments. The goal of such segmentation methods is to predict consumer behavior and classify consumers into clusters based on observable characteristics. Factors used to segment the population into clusters include demographic data such as age, marital status, and income. Other factors include behavioral data such as tendency to purchase a particular product or service.

A common shared constraint of existing consumer behavior segmentation schemas for some applications is that they are difficult or unable to be applied to segment secondary or alternative data sets. They are restricted in some circumstances to use only in applications where there is access to the original base data used in defining the schema. For example, household level segmentation schemas defined on a base set of household characteristics can only be used to segment datasets for some applications with the same exact set of base characteristics. The same is true of geographic systems such as block level or ZIP+4 level, since they require base level geographic data inputs as defined in their original schema. This limits the usability of consumer segmentation for many applications as the development of distinct and separate schemas are required for applications that do not share the exact same base data.

### BRIEF DESCRIPTION OF THE DRAWINGS

In the following, the disclosed embodiments of the invention will be explained in further detail with reference to the drawings, in which:

FIG. 1 is a flow chart illustrating a generalized population segmentation developmental method according to a disclosed embodiment of the invention;

FIG. 2 is a generalized flow chart illustrating a population segmentation application method according to a disclosed embodiment of the invention;

FIG. 3 is a flow chart of a specific example of a population segmentation developmental method;

FIGS. 4 and 5 are flow charts of a specific example of a classification tree, illustrating a downshift in resolution;

FIGS. 6 and 7 are flow charts of another specific example of a classification tree, illustrating a level upshift in resolution;

FIG. 8 is a block diagram of a population segmentation developmental system according to a disclosed embodiment of the invention; and

FIG. 9 is a block diagram of a population segmentation application system according to a disclosed embodiment of the invention.

### DESCRIPTION OF CERTAIN EMBODIMENTS OF THE INVENTION

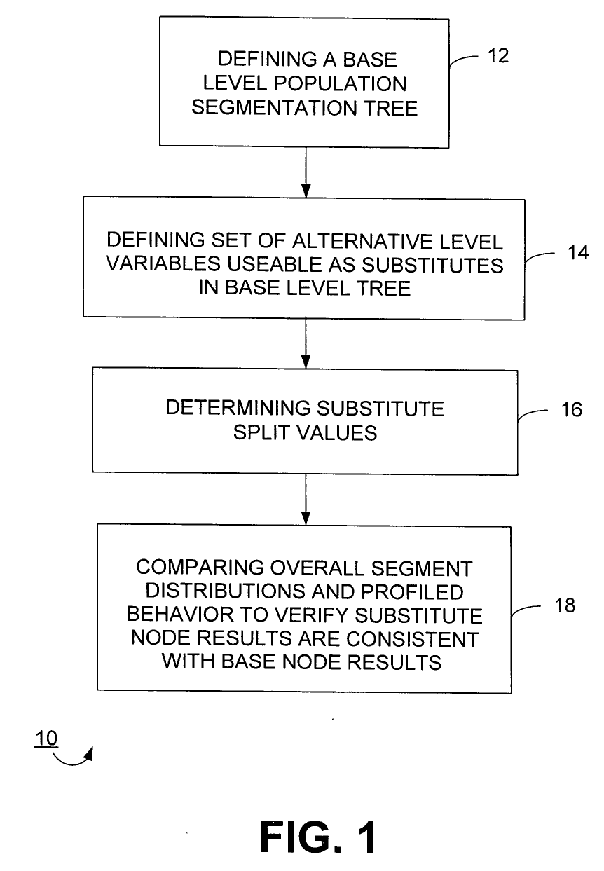

Referring now to the drawings and, more particularly, to FIG. 1 thereof, there is shown a developmental method, which is generally indicated at 10 and which is undertaken according to an embodiment of the invention. The method 10 generally comprises the defining of a base level population segmentation tree as indicated at box 12. The base level for the tree may be the household level. Such a tree method is disclosed in co-pending U.S. patent application, entitled “HOUSEHOLD LEVEL SEGMENTATION METHOD AND SYSTEM” and assigned application Ser. No. 09/872,457 filed Jun. 1, 2001, the application being incorporated herein by reference as if fully set forth in its entirety.

It is indicated in box 14, a set of alternate level variables are defined to be usable as substitutes in the base level tree as hereinafter described in greater detail. As indicated at box 16, the substitute split values are determined for each node of the base level tree, as further explained in greater detail hereinafter. Once the substitute split values are determined, as indicated at box 18, a verification can be undertaken by comparing the overall segment distributions and profiled behavior to ensure the consistency of the results whether using the base level or an alternate other level. In this regard, the substitute node results are compared with the base node results to determine a consistency for verification purposes.

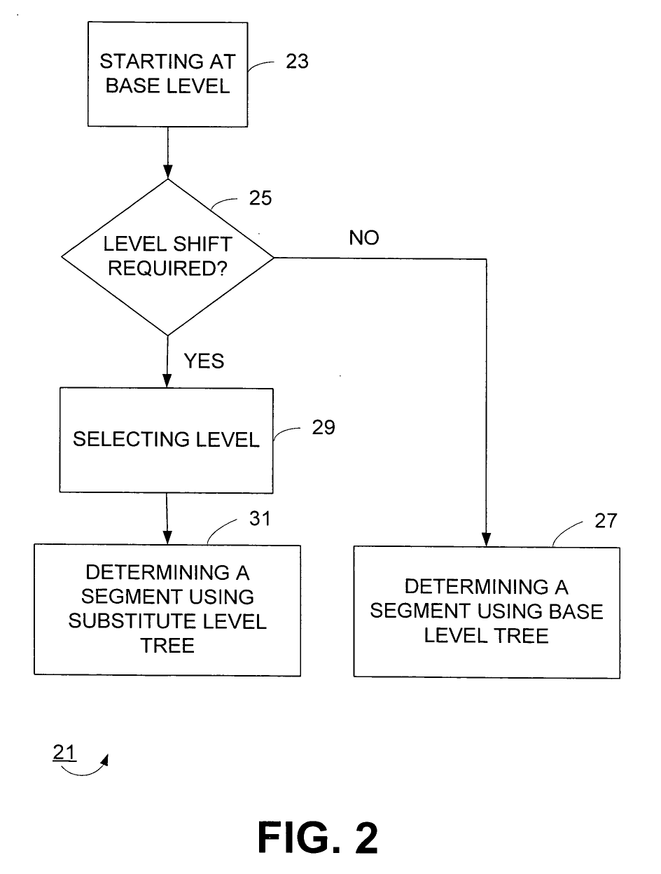

Once the alternate level variables are defined and the split values are determined, as shown in FIG. 2, an application method, which is generally shown at 21 and which is undertaken according to an embodiment of the invention. The method 21 starts at the base level as indicated at box 23, and then a determination is made as to whether or not a level shift is required at box 25. If a level shift is not required, then, as indicated at box 27, a segment is determined using the base level tree such as indicated in the aforementioned U.S. patent application incorporated herein by reference.

If a level shift is required, then, as indicated at box 29, a level is selected, and a segment is determined using the substitute level tree as indicated at box 31.

For purposes of the examples disclosed herein, the following table describes the list of typical segmentation levels:

| LEVELS | NO. OF HOUSEHOLDS |
|---|---|
| HOUSEHOLD | 1 HOUSEHOLD |
| ZIP + 4 | 5 HOUSEHOLDS |
| BLOCK GROUP | 350 HOUSEHOLDS |
| TRACT | 1657 HOUSEHOLDS |
| ZIP CODE | 3657 HOUSEHOLDS |

According to the Method 21, a level shift can occur either upwardly or downwardly. A downward shift would be from a higher level such as the Household level, to a lower level such as the Tract Group level. An upshift occurs from a lower level, such as the ZIP Code to an upper level such as the ZIP+4 level. In this regard, the highest level is the Household level, since the variables such as income and age are collected for each individual household. As the table indicates, the bottom four levels are geographic levels and each contains a given number of households. Thus, the geographic levels are less precise and are, thus, at a lower level than the Household level.

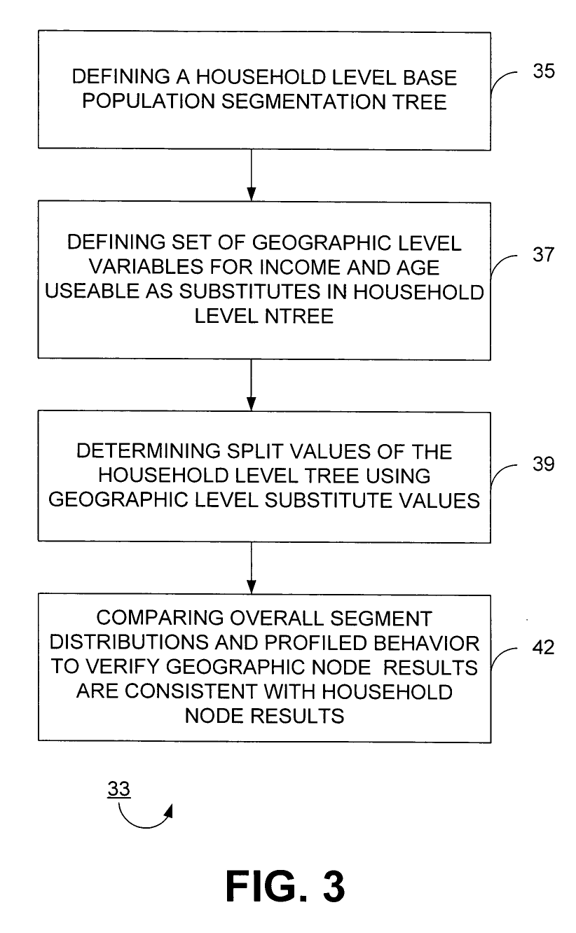

Referring now to a more specific example, reference may be made to FIG. 3. In FIG. 3, there is shown an example of a developmental method 33, which starts with the defining a Household base level population segmentation tree as generally indicated at 35. A set of geographic level variables are defined for income and age usable as substitutes in the Household level tree as indicated at box 37. The split values of the Household level tree are determined using geographic level substitute values as indicated at box 39.

Once these definitions and determinations are made, as indicated at box 42, the overall segment distributions and profiled behavior are compared to verify the results as being consistent. In this regard, geographic node results are compared with household node results to determine whether or not they are consistent. If so, then the substitute values are deemed to be consistent with the base level values.

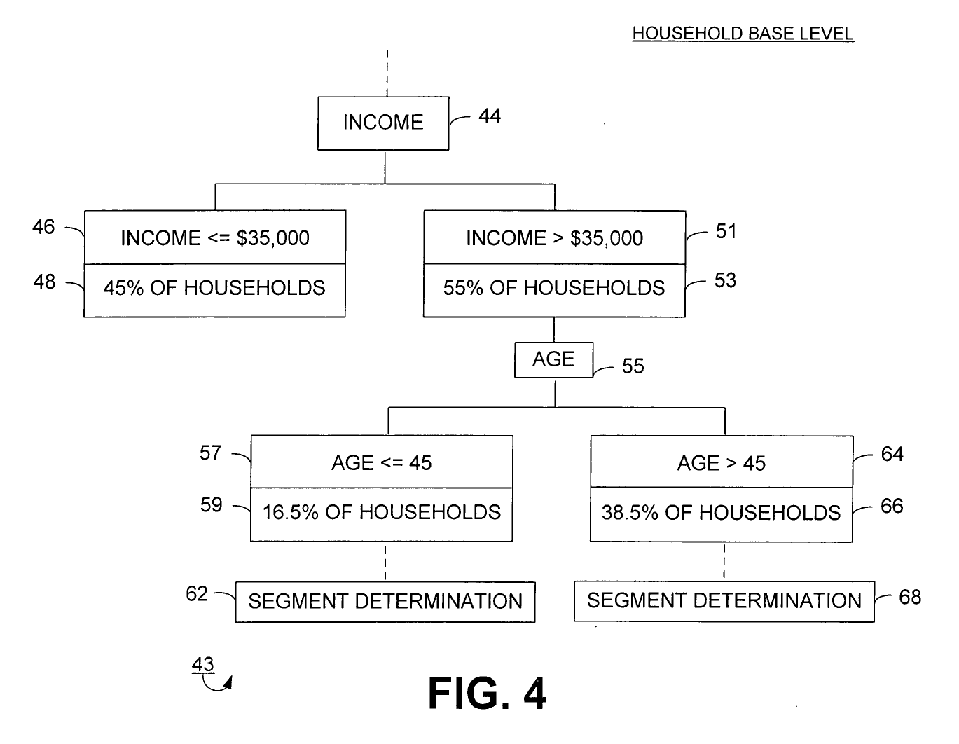

As shown in FIG. 4, an application method generally indicated at 43 is illustrated. The method 43 is a household base level tree system. At an income node of 44, a split is determined in the income of the population. As indicated at box 46, an income of less than or equal to $35,000 is determined to be 45% of the households that indicated at box 48. As indicated at box 51, an income of greater than $35,000 produces a split of 55% of the households as indicated at box 53.

Subsequent nodes such as an age node is then determined. Under the income of greater than $35,000, an age node 55 has a split at box 57 of an age equal to or less than 45 years of age, resulting in a split of 16.5% of the households as indicated at box 59. This then may result ultimately in a segment determination as indicated at box 62.

At an age of greater than 45 as indicated at box 64, this results in 38.5% of the households as indicated at box 66 for the household base level tree. This would then ultimately result in a segment determination at box 68.

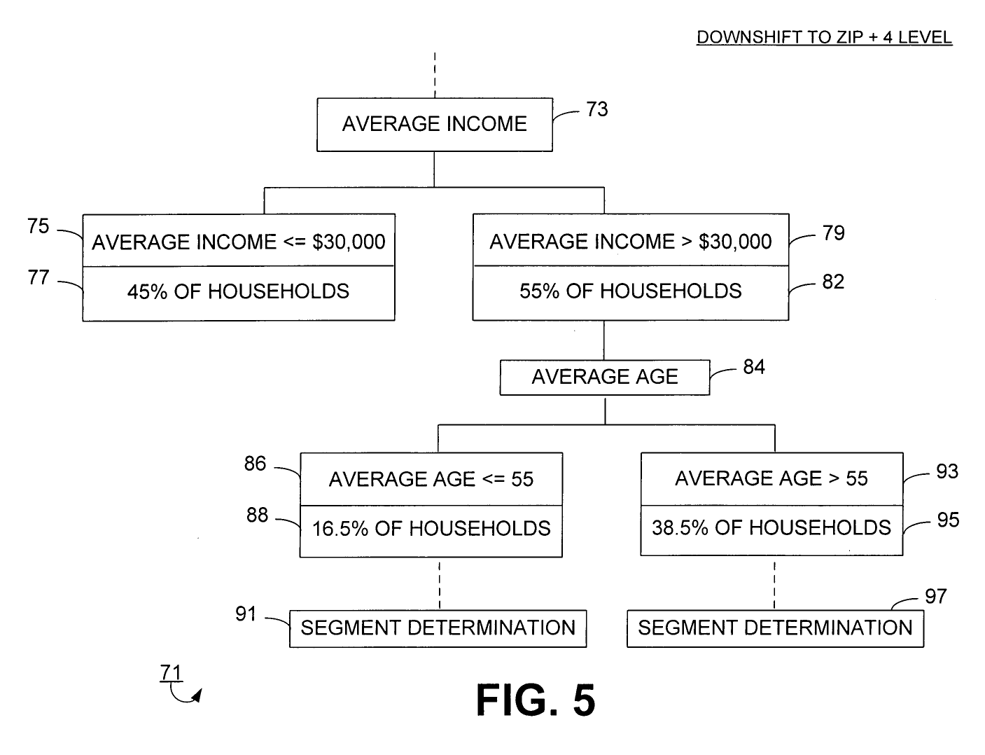

Considering now a downshift to a lower level in the geographic level grouping as indicated in FIG. 5, a downshift from a household base level to a ZIP+4 level will now be considered. At an average income node such as indicated at box 73, a split is determined in the tree using the substitute variables for the average income of equal to or less than $30,000 as indicated at box 75, resulting in 45% of the households as indicated at box 77 for a ZIP+4 segmentation level. It is noted that the same split value of $30,000 is used consistent with the base level as shown in FIG. 4.

At the split for an average income of greater than $30,000 as indicated at box 79, it is determined that 55% of the households for the ZIP+4 level is indicated at box 82.

The average age nodes are used at the same split values as used for the base level. For example, under the average income greater than $30,000, an average age node 84 is split at an average age of less than or equal to 55 as indicated at box 86 to result in 16.5% of the households for the ZIP+4 level as indicated at box 88. This split would then ultimately result in a segment determination as indicated at box 91. Similarly, at the average age of greater than 55 as indicated at box 93, 38.5% of the households are greater than 55 years of age for the ZIP+4 level as indicated at box 95. This would then ultimately result in a segment determination as indicated at box 97.

Thus, the same split in the number of households for both income and age are used for all five levels. Thus, in the household base level, the base level tree results in one of a given number of segments (such, for example, as 66 segments). Additionally, each one of the geographic lower levels will also result in one of the same given number of segments, such, for example, as 66 segments.

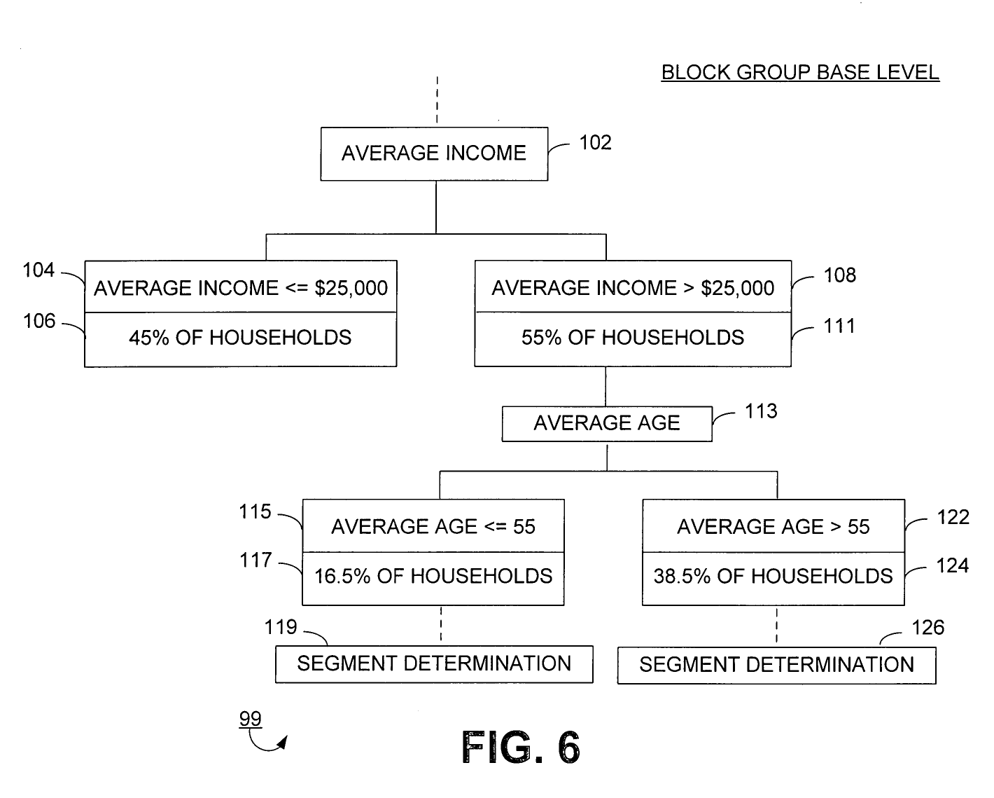

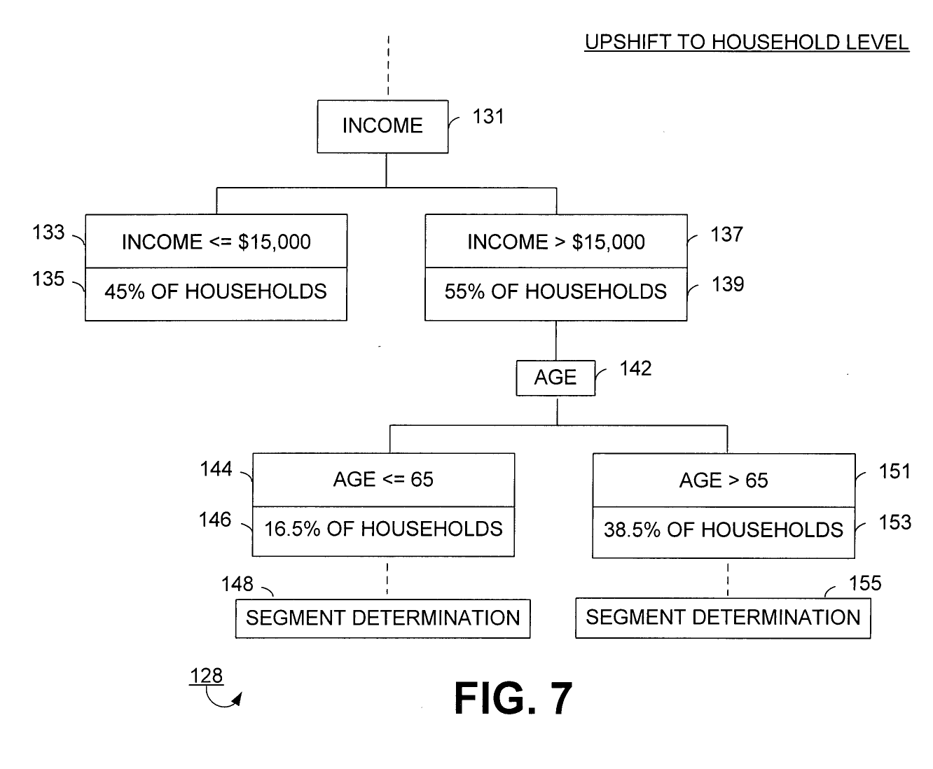

Referring now to FIGS. 6 and 7, an upshift between segmentation levels will now be described. As shown in FIG. 6, a method 99 is shown for a block group base level. At an average income node as indicated at box 102, a split of income is determined. As indicated at box 104, an average income of less than or equal to $25,000 per year as indicated at box 104, results in 45% of the households in the block group as indicated at box 106.

As indicated at box 108, an average income of greater than $25,000 is determined for 55% of the households of the block group base level as indicated at box 111.

An average age split is determined as indicated at box 113 for the average income greater than $25,000. As indicated at box 115, an average age of equal to or greater than 55 results in 16.5% of the households at box 117. To ultimately cause a segment determination at box 119. Similarly, at box 122, an average age of greater than 55 results in 38.5% of the households of the block group as indicated at box 124, resulting ultimately in a segment determination at box 126.

As shown in FIG. 7, an upshift to a household level from the block group base level, can take place at an income node as indicated at box 131. It is determined that at box 133 an income of less than or equal to $15,000 is the income for 45% of the households at the household level as indicated at box 135. An income of greater than $15,000 as indicated at box 137 is the income for 55% of the households at the base household level as indicated at box 139.

At an age node such as indicated at box 142 for the incomes greater than $15,000, at an age of less than or equal to 65 years of age as indicated at box 144, there are 16.5% of the households having persons at that age level as indicated at box 146. This results ultimately in a segment determination at box 148.

At an age greater than 65, as indicated at box 151, 38.5% of the households have people under that age for the household level as indicated at box 153. This results ultimately in a segment determination as indicated at box 155.

It should be noted that in both the upshift and downshift examples, the average income and average ages are used at the lower geographical levels. Also, by using the method and system of the embodiments of the invention, the same number of segments are used for both the base level and the substitute levels. For example, in a household level tree, there may be a segmentation of 1 of 66 segments. Each one of these substitute lower levels will also result in one of 66 segments.

The disclosed method and system may be developed at the household level. The system schema disclosed herein, uniquely classifies households into 1 of 66 segments. The segments are designed so that the households assigned into a specific segment will be expected to share common consumer and demographic behaviors and characteristics. Assignment into a segment is done using characteristics that are associated with the household such as age, income, presence of children, type of neighborhood in which the household resides. A patent is pending for the methodology used to develop the household schema.

The disclosed system and method constitute a comprehensive solution as the system extends beyond its base household level and is made usable for geographic assignment of segment codes. Segmentation schemas according to the disclosed embodiments of the invention provide the same set of segment assignments at both the household and geographic levels. In applications requiring both levels, household and geographic, two completely different systems are usually required. One system that uses household level data only with one set of segment definitions, and another system that uses geodemographic data only with its own unique set of segments.

The disclosed embodiments of the present invention provide a segmentation system for classifying a population into market segments that can be used to describe, target and measure consumers by their demand for and use of particular products and services. The segments are optimized to provide high-lift profiles for the evaluation profiles.

The disclosed process takes a base household level schema and uses that schema to assign the same segment codes using an alternative geodemographic data set. The basic process, referred to as “upshift/downshift,” can also be applied in other techniques as well. For example, the method and apparatus of the embodiments of the invention can be used to transfer between a variety of levels such as a transfer from a geographic system to households, from a household system to individuals, or from a household system to another household data set that does not have the exact same variables as used in the original schema.

Having the same set of segments at all levels, household and geographic, greatly simplifies the use of segmentation as well as reducing the support and maintenance requirements for segmentation system providers. Simplification in use comes from not being forced into either household or geodemographic systems. Now companies would have access to a unified system that can be applied at whatever level is reasonable for the given application. For providers of segmentation systems, it means not having to support and maintain a suite of different segmentation systems tailored to various levels, they now only have to support one system across all levels. This allows for a focusing of resources with a potential reduction in costs.

The process uses characteristics in an alternative data set to uniquely assign segments from the base schema to records in the alternative data set. The assignments must be done in such a way so that if a file is coded using the base system and compared with the codes assigned using the alternative data set, general predictions of behavior and overall descriptive statistics will be the same. That is, using the base or alternative system for analysis will generate the same general conclusions. The only difference may be in the clarity or precision of the analysis.

In the preferred embodiment of the invention, the base is the household level schema, and the alternative is a geographic version. The system can shift down from the household level schema to lower geographic levels. This shift is referred to as a down shift, because the move from the household level to a geographic level results in a lower level of precision.

The method starts with the base node table for a tree based segmentation system. The base system is the system for which an equivalent system at a different level is to be developed. For example, the base system could be at the household level and the alternative system the ZIP+4 versions. Define a set of variables for the alternative level that map into those required for the base system. This requires creation of a set of variables for the alternative level that can be used as substitutes in the node table for the base level schema. Continuing the example, this would require creation of ZIP+4 level measures for income, age, presence of children to use as substitutes for household income, age, and presence of children in the household level node table.

Using the substitute variables, rework the split values in the base node table so that at each split the percent of households on each side of the split is maintained. For example, assume that the base node table had an income split at $35,000 with 45% of the households having income less than or equal. to $35,000 and 55% having income greater than $35,000. For the alternative system, this split would be set using the ZIP+4 income so that 45% of the households across all ZIP+4s have ZIP+4 level income less than or equal to the new split value and 55% would be in ZIP+4s with income greater than the split. At the ZIP+4 level, this new split could be a value like $30,000. Verify that the node table created for the alternative geography creates results which are consistent with the base node table. This is done by comparing overall segment distributions and profiled behavior.

It is assumed that the base system can be defined using a node table or tree structure. Statistical routines that create these types of systems are often referred to as Classification Trees, Decision Trees, Divisive Partitioning, or CART. The common thread is these routines create rules which are mutually exclusive and exhaustive for classification of data. The “upshift/downshift” methodology can be applied to any set of rules that classify data in this manner. They also work in any direction. A higher level system such as a household level could be pushed down to a lower or smaller level such as a geographic level, as well as lower level systems pushed up to larger or higher levels such as to the household level. Thus, the name “upshift/downshift.”

As an example of a downshift to a lower level, assume that a base schema with three segments has been defined using household level age and income. The node table for this base schema follows:

| Split | | | | | | | |
|---|---|---|---|---|---|---|---|
| num- | Split | | Left | Right | % | % | % at |
| ber | Variable | Value | Branch | Branch | Left | Right | Split |
| 1 | Income | $35,000 | 2 | 3 | 45% | 55% | 100% |
| 2 | Terminal | | | | | | 45% |
| 3 | Age | 45 | 4 | 5 | 30% | 70% | 55% |
| 4 | Terminal | | | | | | 16.5% |
| 5 | Terminal | | | | | | 38.5% |

The tree structure for this schema is shown in FIG. 4.

In order to illustrate an example of the downshift to another level, an alternative ZIP+4 level schema may be developed according to an embodiment of the invention. In the ZIP+4 level alternative data set, substitute variables are created for income and age. Logical choices may be the average income and average age for households in each ZIP+4 level. Each ZIP+4 level must also have a household count. The split values in the base schema are calculated using the ZIP+4 level substitute values so that the reported household percents in the base schema are maintained.

The resulting alternative ZIP+4 node table for this may be:

| Split | | | | | | | |
|---|---|---|---|---|---|---|---|
| num- | Split | | Left | Right | % | % | % at |
| ber | Variable | Value | Branch | Branch | Left | Right | Split |
| 1 | Average | $30,000 | 2 | 3 | 45% | 55% | 100% |
| | Income | | | | | | |
| 2 | Terminal | | | | | | 45% |
| 3 | Average | 55 | 4 | 5 | 30% | 70% | 55% |
| | Age | | | | | | |
| 4 | Terminal | | | | | | 16.5% |
| 5 | Terminal | | | | | | 38.5% |

The tree structure for this alternative schema is shown in FIG. 5.

Considering now an upshift to a higher level, such as from a geographic level to the household level, assume for example, a base schema with 3 segments has been defined using block group level average age and average income. The node table for this base schema follows:

| Split | | | | | | | |
|---|---|---|---|---|---|---|---|
| num- | Split | | Left | Right | % | % | % at |
| ber | Variable | Value | Branch | Branch | Left | Right | Split |
| 1 | Average | $25,000 | 2 | 3 | 45% | 55% | 100% |
| | Income | | | | | | |
| 2 | Terminal | | | | | | 45% |
| 3 | Average | 55 | 4 | 5 | 30% | 70% | 55% |
| | Age | | | | | | |
| 4 | Terminal | | | | | | 16.5% |
| 5 | Terminal | | | | | | 38.5% |

The tree structure for this schema is shown in FIG. 6.

An alternative level schema would be developed by the level alternative data set, substitute variables created for average income and average age. Logical choices may be the household income and household age. Calculate the split values in the base schema using the household level substitute values so that the reported household percents in the base schema are maintained. The resulting alternative ZIP+4 node table for this may be:

| Split | | | | | | | |
|---|---|---|---|---|---|---|---|
| num- | Split | | Left | Right | % | % | % at |
| ber | Variable | Value | Branch | Branch | Left | Right | Split |
| 1 | Income | $15,000 | 2 | 3 | 45% | 55% | 100% |
| 2 | Terminal | | | | | | 45% |
| 3 | Age | 65 | 4 | 5 | 30% | 70% | 55% |
| 4 | Terminal | | | | | | 16.5% |
| 5 | Terminal | | | | | | 38.5% |

The tree structure for this alternative schema is shown in FIG. 7.

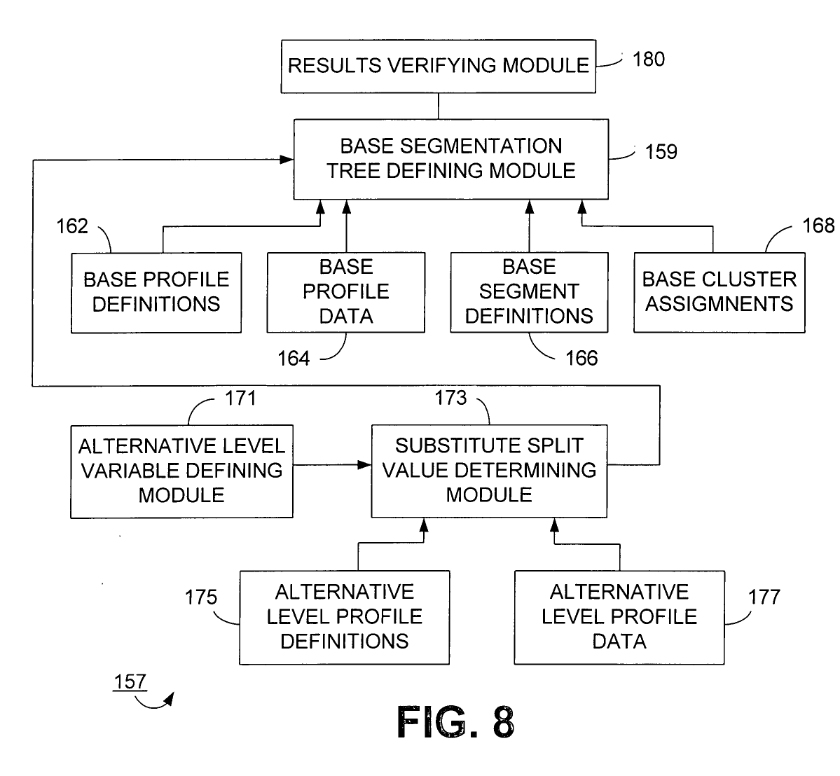

Referring now to FIG. 8, there is shown a population segmentation developmental system 157 used to execute the method of FIG. 1, in accordance with an embodiment of the invention. The system 157 includes a base segmentation tree defining module 159 which receives information from a base profile definitions database 162, a base profile data 164, a base segment definitions database 166 and a base cluster assignments database 168 to facilitate the defining of the base segmentation tree. This system is more fully and accurately described in connection with the aforementioned U.S. patent application incorporated herein by reference. It is to be understood that other different types and kinds of segmentation tree defining modules may be employed as will become apparent to those skilled in the art.

In order to facilitate the implementation of an alternate level segmentation tree using the same base segments, an alternative level variable defining module 171 communicates with a substitute split value determining module 173. The module 173 communicates with and obtains information from alternative level profile definitions database 175 and alternative level profile data 177 in accordance with the method of FIG. 1.

The results verifying module 180 compares the results of the base segmentation tree with the results obtained from the segmentation tree using alternative level variables provided by the module 173.

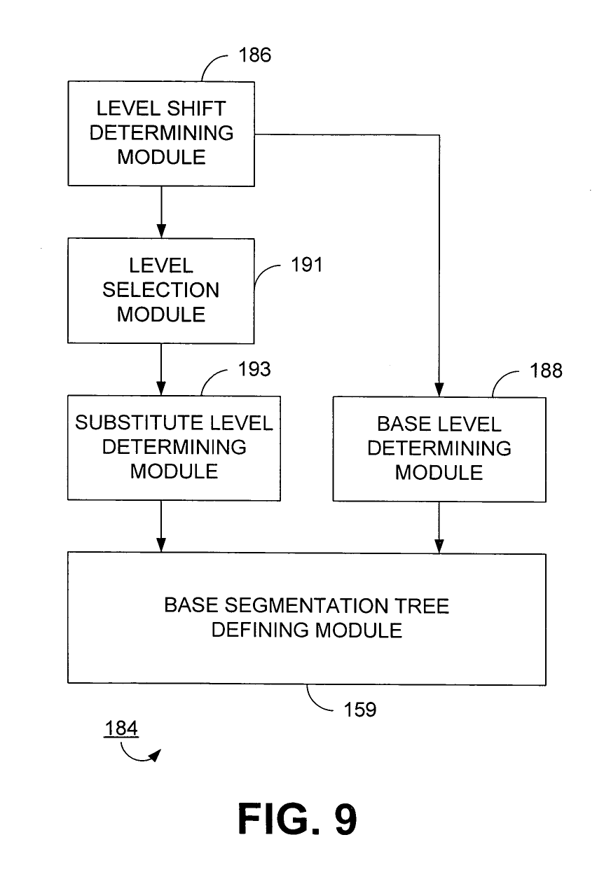

Referring now to FIG. 9, there is shown a population segmentation application system 184, which is useful in executing the method of FIG. 2, and which is constructed in accordance with an embodiment of the invention. The system 184 includes a level shift determining module 186 to facilitate making the determination as to whether or not a level shift is required. The module 186 activates a base level determining module 188 when it is determined that a level shift is not to be executed. The module 188 then communicates with the base segmentation tree defining module 159 to enable it to determine the base segmentation.

Alternatively, the module 186 communicates with a level selection module 191 when it is determined that a level shift is required. A substitute level determining module 193 communicates with the module 191 to provide the necessary substitute variables to the base segmentation tree defining module 159, which in turn provides the segmentation based upon the substitute variables in accordance with the method of FIG. 2.

While particular embodiments of the present invention have been disclosed, it is to be understood that various different modifications and combinations are possible and are contemplated within the true spirit and scope of the appended claims. There is no intention, therefore, of limitations to the exact abstract or disclosure herein presented.

1. A method for segmenting a population, comprising:
generating population segmentation trees based on demographic data and on behavioral data for a set of consumers;
defining a base level population segmentation tree;
defining a set of alternative level variables useable as substitutes in the nodes of the population segmentation tree; and
determining substitute split values for each node of the tree to enable up and down shifting between levels.

2. A method according to claim 1, further including determining whether a level shift is required.

3. A method according to claim 2, further including determining segments using the base level tree when no level shift is required.

4. A method according to claim 2, further including determining segments using another level when a level shift is required.

5. A method according to claim 4, wherein a level is determined when a level shift is required.

6. A method according to claim 1, further including generating population segmentation trees based on demographic data and on behavioral data for a set of consumers.

7. A method according to claim 1, wherein the split values are for income and age.

8. A method according to claim 1, further including verifying the results of a segment determination when using substitute values.

9. A system for segmenting a population, comprising:
means for generating population segmentation trees based on demographic data and on behavioral data for a set of consumers;
means for defining a base level population segmentation tree;
means for defining a set of alternative level variables useable as substitutes in the nodes of the population segmentation tree; and
means for determining substitute split values for each node of the tree to enable up and down shifting between levels.

10. A system according to claim 9, further including determining whether a level shift is required.

11. A system according to claim 10, further including determining segments using the base level tree when no level shift is required.

12. A system according to claim 10, further including determining segments using another level when a level shift is required.

13. A system according to claim 12, wherein a level is determined when a level shift is required.

14. A system according to claim 9, further including generating population segmentation trees based on demographic data and on behavioral data for a set of consumers.

15. A system according to claim 9, wherein the split values are for income and age.

16. A system according to claim 9, further including means for verifying the results of a segment determination when using substitute values.

17. A software system for segmenting a population, comprising:
a module for generating population segmentation trees based on demographic data and on behavioral data for a set of consumers;
a module for defining a base level population segmentation tree;
a module for defining a set of alternative level variables useable as substitutes in the nodes of the population segmentation tree; and
a module for determining substitute split values for each node of the tree to enable up and down shifting between levels.

18. A software system according to claim 17, further including determining whether a level shift is required.

19. A software system according to claim 18, further including determining segments using the base level tree when no level shift is required.

20. A software system according to claim 18, further including determining segments using another level when a level shift is required.

21. A software system according to claim 20, wherein a level is determined when a level shift is required.

22. A software system according to claim 17, further including generating population segmentation trees based on demographic data and on behavioral data for a set of consumers.

23. A software system according to claim 17, wherein the split values are for income and age.

24. A software system according to claim 17, further including a module for verifying the results of a segment determination when using substitute values.

25. A software product for segmenting a population produced by the following steps, comprising:
generating population segmentation trees based on demographic data and on behavioral data for a set of consumers;
defining a base level population segmentation tree;
defining a set of alternative level variables useable as substitutes in the nodes of the population segmentation tree; and
determining substitute split values for each node of the tree to enable up and down shifting between levels.

26. A software product according to claim 25, further including determining whether a level shift is required.

27. A software product according to claim 26, further including determining segments using the base level tree when no level shift is required.

28. A software product according to claim 26, further including determining segments using another level when a level shift is required.

29. A software product according to claim 28, wherein a level is determined when a level shift is required.

30. A software product according to claim 25, further including generating population segmentation trees based on demographic data and on behavioral data for a set of consumers.

31. A software product according to claim 25, wherein the split values are for income and age.

32. A software product according to claim 25, further including means for verifying the results of a segment determination when using substitute values.
